(19) United States
(12) Patent Application Publication
(10) Pub. No.: US 2009/0009736 A1
(43) Pub. Date: Jan. 8, 2009

(54) Apparatus for and Method of Forming Optical Images

(75) Inventors: Roger Anton Marie Timmermans, Eindhoven (NL); Johannes Hubertus Antonius Van De Rijdt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/576,668

(22) PCT Filed: Oct. 20, 2004
(86) PCT No.: PCT/IB04/52157

§ 371 Date: Apr. 21, 2006

(30) Foreign Application Priority Data
Oct. 27, 2003 (EP) 03103970.4

(51) Int. Cl. G03B 27/42

(52) U.S. Cl. 355/53; 355/77

(57) ABSTRACT

In an apparatus for forming an image in a radiation sensitive layer (6) and comprising an array (16) of light valves (18-22) and a corresponding array (40) of converging elements (46) the positions of radiation spots (204) formed by these arrays (16,40) are monitored and their positions determined by means of a sensing module, which is arranged below the plane of the spots. The module is provided with a slit plate (182) showing pair of slits (186,188) and with position encoders (190,192,194,196) and the plate carrying the converging elements is provided with tracking configurations (171,173,175,177) and alignment marks (198).

The invention relates to an apparatus for forming an optical image in a radiation-sensitive layer, which apparatus comprises:
a radiation source for supplying an exposure beam of radiation;
positioning means for positioning a radiation sensitive layer with respect to the exposure beam;
an array of individually controllable light valves arranged between the radiation source and the location for the radiation-sensitive layer, and
a two-dimensional array of converging elements arranged on a converging plate between the array of light valves and the substrate holder such that each converging element corresponds to a different one of the light valves and serves to converge exposure radiation from the corresponding light valve in a spot in the radiation-sensitive layer.

The invention also relates to a method of forming optical images in a radiation sensitive layer and to a process for manufacturing a device using this method and apparatus.

An array of light valves, or optical shutters, is understood to mean an array of controllable elements, which can be switched between two states. In one of the states radiation incident on such an element is blocked and in the other states the incident radiation is transmitted or reflected to follow a path that is prescribed in the apparatus of which the array forms part. Such an array may be a transmission- or reflective liquid crystal display (LCD), a digital mirror device (DMD) or any other device comprising micron-sized light valves. These arrays usually are two-dimensional arrays. Is also possible to use a linear array, such as a grating light valve, which is discussed in U.S. Pat. No. 6,177,980. A grating light valve array can be switched with very high frequencies. Such a linear array may be combined with a beam scanner, for example a rotating mirror, which is arranged between the array of light valves and the converging plate to scan the sub-beams from the individual light valves across the converging plate in direction perpendicular to the length direction of the linear array. The radiation sensitive layer is, for example a resist layer used in optical lithography, or an electrostatic charged layer used in a printing apparatus. The term light valve is quite current and will be used in this description, although in the present apparatus the light valves will be mostly used for switching other radiation than visible light. In the lithographic imaging apparatus the array of light valves may be used to form an image with electromagnetic radiation in a broad wavelength range covering visible light as well as ultraviolet (UV) radiation and deep UV (DUV) radiation. The converging elements may be of the type refractive lens or of the type diffraction element, such as a diffraction lens.

As described in PCT patent application WO 03/052515 A1, such an apparatus and method may be used, inter alia, in the manufacture of devices such as liquid crystalline display (LCD) panels, customized-ICs (integrated circuits) and PCBs (printed circuit board). The apparatus may be a proximity printing apparatus, wherein the array of converging elements is arranged at a short distance, called the proximity gap, from the radiation-sensitive layer on top of the substrate. The apparatus may also be a projection apparatus, wherein a projection system, such as a projection lens system, is arranged between the array of light valves and the array of converging elements, to image each light valve on its corresponding converging element of the array.

The apparatus utilising an array of individually switchable light valves was proposed as a better alternative to a lithographic projection apparatus of the type wafer stepper or of the type wafer step-and scanner. In a wafer stepper, a whole mask pattern, for example an IC pattern is imaged at one go by a projection system, such as a lens system or a mirror system, on a first IC area of the substrate. Then the mask and substrate are moved (stepped) relative to each other until a second IC area is positioned below the projection lens. The mask pattern is then imaged on the second IC area. These steps are repeated until all IC areas of the substrate are provided with an image of the mask pattern. This is a time consuming process, due to the sub-steps of moving, aligning and imaging. The latter sub-step is also called exposure.

In a wafer step-and-scanner, only a small portion of the mask pattern is illuminated at once. During illumination, the mask and the substrate are synchronously moved with respect to the illumination beam until the whole mask pattern has been illuminated and a complete image of this pattern has been formed on an IC area of the substrate. Then the mask and substrate are moved relative to each other until the next IC area is positioned under the projection lens and the mask pattern is again scan-illuminated, so that a complete image of the mask pattern is formed on said next IC area. These steps are repeated until all IC areas of the substrate are provided with a complete image of the mask pattern. The step-and-scanning process is even more time consuming than the stepping process.

For the manufacture a device such as an IC by means of a wafer stepper or a wafer step-and-scanner a number of masks is needed corresponding to the number of substrate layers, which have to be configured with specific device features. The manufacture of each of these masks is a time consuming and cumbersome process, which renders such a mask costly. If re-design of a mask is needed, which is often the case in practice, or in case customer-specific devices, i.e. a relative small number of the same device, have to be manufactured, the lithographic manufacturing method using masks is an expensive method. Similar remarks can be made with respect to the manufacture of LCD panels or other display panels.

An array of individually switchable light valves, when used in a lithographic apparatus, functions as a flexible, in the sense of programmable, mask. The image content of such a mask can easily be changed by switching each individual light valve such that the image element, or pixel, formed by a light valve is light or dark. The lithographic imaging apparatus using an array of light valves is a multiple spot scanning apparatus wherein a large number of spots simultaneously scan the radiation-sensitive, or resist, layer to simultaneously write portions of the required image in this layer. Thereby different scan modes can be used. For example, each of the spots may write an area having dimensions up to some tens times the spot size, or a group of spots may be used to write the same area of the resist layer.

Experiments have learned that for a successful use of the combination of a light valve array and an array of converging elements in a lithographic or other printing apparatus and method, additional means are needed

It is an object of the invention to provide such means. According to a first aspect of the invention, an apparatus as defined in the opening paragraph is characterized by monitoring means for individually monitoring the spots formed by the convergent elements and/or determining the positions of these spots with respect to the radiation sensitive layer, which means are arranged downstream the array of converging elements and use the exposure beam radiation.

These means allow determining accurately the position of the exposure spots, formed by the two arrays, and the radiation-sensitive layer very accurate with respect to each other. The exposure spots are the spots by means of which a required pattern is written in the radiation-sensitive layer. Moreover, the means allow determining the parameters of the exposure spots so that possible deviations in these parameters can be compensated for during writing of the pattern. The spot parameters are the spot presence, the spot shape, the spot size, the spot intensity etc.

It should be noted that U.S. Pat. No. 6,133,986 discloses a lithographic projection apparatus of the type described in the opening paragraph wherein the converging elements are micro lenses, which apparatus comprises position-detecting means. This means is used to provide feedback to a closed-looped wafer-positioning servomechanism. However, this means uses a Moiré technique in which the periodic pattern of the micro lenses is measured on a periodic tracking pattern, i.e. a grating etched in the wafer. Radiation that has passed the micro lens and is reflected by the grating structure shows Moiré pattern. This pattern is projected by a projection lens system on an optical detector array, which is arranged at the same side of the projection lens system as the array of light valves. The optical detector array is a position encoder, which is arranged at a position remote from the array of micro lenses. The optical detector array is not used to monitor parameters of the individual spots formed by the array of micro lenses and the spot position measurement is based on another principle than that used in the apparatus of the present invention. Moreover, for position encoding radiation is used that has a wavelength different from the wavelength of the exposure radiation, so that a correction of the micro lenses for the encoder radiation is necessary.

Preferably, the apparatus is further characterized in that the monitoring means comprises a movable module, which is provided with a slit plate comprising an array of slits and a corresponding array of radiation detectors in register with the slits.

The radiation detectors may be constituted by the cells of a CCD sensor or C-MOS sensor, which are currently used in a digital camera. The sensing monitor may be moved in a direction perpendicular to the scan direction to successively scan all exposure spots arranged along a line in this direction. In the scan direction the slit plate then comprises a number of slits equal to the number of spots one wants to scan simultaneously. The scan direction is understood to mean the direction in which the spots and the radiation-sensitive layer are moved with respect to each other for writing the required image in the radiation-sensitive layer. By moving the module across the array of spots the position and/or parameters of all spots within a surface area, which in one direction is determined by the number of slits and their interspacing and in the perpendicular direction is determined by the module scan length, are successively measured.

Preferably, the sensing module is a separate unit, which is arranged in the apparatus such that the array of spots, before arriving at the radiation-sensitive layer, firstly pass the area wherein the module is moved. The time required for spot measurement is then minimum. In case the invention is implemented in a lithographic apparatus, the sensing module may also be integrated in the substrate stage.

To determine the positions of the spots in both the scan direction and in the direction perpendicular thereto, the apparatus is further characterized in that the slit plate comprises a first and a second series of slits whereby the slits of the first and second series extend in different directions with respect to the direction of movement of the sensing module.

The slits of the first series and the slits of the second series may extend in a direction perpendicular and in a direction at a sharp angle, respectively to the said direction of movement and the slits of the second series may extend in a direction at a sharp angle to the scan.

Then the first series of slits, and corresponding detector cells is used to determine the spot positions in the direction of movement, which direction may be called X-direction, whilst the second series of slits is used to determine the spot positions in the direction, perpendicular to the direction of movement, which direction may be called Y-direction.

Preferably, the apparatus is characterized in that the slits of the first series and the slits of the second series extend in a direction at a first sharp angle and in a direction at a second sharp angle, opposed to the first sharp angle, respectively the said direction of movement.

This configuration allows determining, not only the spot positions with respect to the module, but also the parameters of the exposure spots.

To allow determining the spot positions with respect to the plate equipped with the converging elements, the apparatus is further characterized in that the sensing module comprises at least one X-position encoder and at least one Y-position encoder, and in that the converging plate is provided with at least one X-tracking configuration and at least one Y-tracking configuration.

Position encoders are well known in the art and encoders of a known type may be built in the sensing module outside the area where the slits for measurement of the spots are arranged. Such an encoder may comprise a periodic structure of transparent strips, e.g. a grating, and a radiation sensitive detector in the path of radiation from the strips. For the X-encoder the strips extend in the Y-direction and for the Y-encoder the strips extend in the X-direction. The X- and Y-tracking configuration may be formed by gratings having their grating strips extending in the Y- and X-direction, respectively and having the same periodicity, or pitch, as the corresponding encoder gratings. Upon illumination of the tracking gratings, by exposure radiation or radiation of another wavelengths, radiation from the grating strips is incident on the encoder gratings. The position of the sensing module with respect to the converging plate in the direction of movement of the module can be determined by counting the number of pulses supplied by the encoder for this direction. The mutual position in the direction perpendicular to the direction of movement of the sensing module and the converging plate can be determined by counting the number of pulses supplied by the encoder for this perpendicular direction.

The tracking gratings may be amplitude gratings or phase gratings and they may be arranged on separate elements, which elements may be fixed to the converging plate. Preferably the tracking grating are integrated with the converging plate, for example the may be etched in the substrate of the converging plate. This allows more accurate position measuring.

The use of position encoders and tracking configurations allows relieving the mechanical requirements for the moving sensing module.

Preferably, this apparatus is characterized in that the sensing module comprises two X-position encoders and two Y-position encoders, and in that the converging plate is provided with two X-tracking configurations and two Y-tracking configurations.

Combining the signals from the two X-position encoders allows determining a rotation of the module in its own plane, i.e. on a Z-axis. Combining the signals from the two Y-position encoders allows determining a possible expansion of the array of converging elements so that the measured spot position can be corrected for such expansion.

By means of the measuring system described so far the positions of the exposure spots with respect to the converging plate gratings can be measured. If the apparatus is further characterized in that the converging plate comprises a number of alignment marks to co-operate with corresponding alignment marks on the substrate, the spot positions with respect to the alignment marks on the converging plate and thus with respect to the alignment marks on the substrate can be determined accurately.

Preferably the apparatus is further characterized in that the alignment marks are arranged close to the tracking configurations in the converging plate.

Thus arrangement allows even more accurate spot position measuring.

This measuring system provides the advantages that it is not sensitive to a non-uniform expansion of the converging plate or to a non-accurate movement of the module and that the position of the spots with respect to the alignment marks on the converging plate can be determined accurately, because these alignment marks are arranged closed to the tracking configurations.

The apparatus may be further characterized in that the converging elements are diffractive elements.

As described in WO 03/052515-A1 the diffraction elements may have at least two transmission levels and at least three phase levels, which allows considerably increasing the diffraction efficiency of the elements. Diffraction efficiency is understood to mean the percentage of the incident radiation that is diffracted in the required diffraction order, for example a first order.

Alternatively and preferably, the apparatus is further characterized in that the converging elements are refractive lenses.

Refractive lenses provide the advantage that their performance is considerably less sensitive to wavelength variations than that of diffractive elements. The refractive lenses have a sharper focus than diffraction elements, because they show no diffraction order splitting.

A first embodiment of the invention is characterized in that the array of converging elements faces the array of light valves without intervening imaging elements.

This embodiment is a type of proximity printing apparatus and the array of converging elements is separated from the radiation-sensitive layer by a small gap, for example an air gap.

A second embodiment of the apparatus is characterized in that an optical projection system is arranged between the array of light valves and that array of converging elements.

The projection system, which may be a projection lens system or a mirror projection system, images each light valve on its associated converging element in the converging plate so that the effects of cross-talk, optical aberrations and temperature variations on the written pattern are eliminated or at least substantially reduced. The projection system matches the size and sub-sizes of the light valve array to those of the converging plate. Moreover, inserting a projection system allows making the substrate of the converging plate relatively thick so that the stability of the apparatus is increased.

The apparatus can be used in several applications. In a first application the apparatus constitutes a lithographic tool for producing a device in at least one layer of a substrate. For this application the apparatus is characterized in that the radiation-sensitive layer is a resist layer on top of a substrate layer to be configured, in that the image corresponds to the pattern of device features to be configured in said substrate layer and in that the positioning means is a substrate holder carried by a substrate stage.

The apparatus may also be used for printing data on a sheet of paper. For this application the apparatus is characterized in that the radiation-sensitive layer is a layer of electrostatic charged radiation-sensitive material and in that the positioning means are means for moving said layer with respect to the array of light valves and the array of converging elements and for sustaining said layer at the location of the image field of this array.

The invention also relates to a method of forming an optical image in a radiation sensitive layer, the method comprising the steps of:
providing a radiation source for generating a beam of radiation;
providing a radiation sensitive layer;
positioning an array of individually controlled light valves between the radiation source and the radiation sensitive layer;
positioning a two-dimensional array of radiation converging elements between the array of light valves and the radiation sensitive layer such that each of these elements corresponds to a different one of the light valves and serves to converge radiation from the corresponding light valve in a spot in the radiation sensitive layer;
simultaneously writing image portions in radiation sensitive layer areas by scanning said layer areas at the one hand and the associated light valves/converging element pairs at the other hand relative to each other and switching each of the light valves between on and off states in dependency of the image portion to be written in by the light valve. This apparatus is characterized in that, prior to writing an image in the radiation-sensitive layer, all light valves are switched on and a control process is carried out to determine parameters of the individual spots and the positions of these spots with respect to the radiation-sensitive layer.

Depending on the circumstances the control process can be carried out before exposure of each substrate or before exposure of a batch of substrates or only at regular longer time intervals, for example at the beginning of each production day. Monitoring the exposure spots before exposure of each substrate renders the method insensitive to temperature drift and allows performing a complete control of the total optical system used with the method. It is also possible that monitoring of the spot parameters is carried out more frequently than determining the spot positions.

Preferably this method is further characterized in that the control process comprises the step of scanning the array of spots and a measuring module comprising an array of slits and a corresponding array of radiation detectors with respect to each other.

The method is further preferably characterized in that the control process comprises the step of determining the position of the measuring module with respect to the lens array by measuring the positions of linear encoders included in the module with respect to tracking configurations provided on the converging plate.

The method is still further preferably characterized in that the control process comprises the step of determining the positions of the spots with respect to the radiation sensitive layer by measuring the positions of alignment marks, which are included in the converging plate with respect to corresponding alignment marks in the substrate.

A first embodiment of the method is characterized in that said scanning is such that each spot scans its own associated layer area, which area has dimensions corresponding to the pitch of the matrix of spots formed by array of converging elements.

According to this method each light valve is used to write only one layer area, hereinafter called light valve area, by two-dimensionally scanning the spot from this light valve across this associated light valve area. After a spot has scanned a line within the light valve area, this spot and the area are moved relative to each other in a direction perpendicular to the scanning direction, where after a next line within this area is scanned etc until the full light valve area has been written.

A second embodiment of the method is characterized in that the matrix of spots and the radiation sensitive layer are scanned relative to each other in a direction at a small angle to the direction of the lines of spots in the matrix and in that the scanning is carried out over a length substantially larger than the matrix pitch.

According to this embodiment all spots of all lines are used to scan different lines and a layer area, having a width corresponding to the total number of spots times the size of a spot and having an arbitrary length, can be scanned by means of one scanning action, without movement in a direction perpendicular to the scanning direction.

The method of the present invention may be further characterized in that between successive sub-illuminations the radiation-sensitive layer and the arrays are displaced relative to each other over a distance, which is at most equal to the size of the spots formed in the radiation sensitive layer.

In this way image, i.e. pattern, features can be written with a constant intensity across the whole feature. The spots may have a circular, square, diamond or rectangular shape, dependent on the design of a beam-shaping aperture present in the apparatus. The size of the spot is understood to mean the size of the largest dimension within this spot.

If features of the image to be written are very close to each other, these features may broaden and flow into each other, which phenomenon is known as proximity effect. An embodiment of the method, which prevents proximity effects from occurring, is characterized in that the intensity of a spot at the border of an image feature is adapted to the distance between this feature border and a neighbouring feature.

The method can be used in several applications. A first application is in the field of optical lithography. An embodiment of the method, which is suitable to form part of a lithographic process for producing a device in at least one layer of a substrate is characterized in that the radiation sensitive layer is a resist layer provided on the substrate and in that image pattern corresponds to the pattern of device features to be configured in the substrate layer.

This embodiment of the method may be further characterized in that the image is divided in sub-images each belonging to a different level of the device to be produced and in that during formation of the different sub-images the resist layer surface is set at different distances from the array of refractive lenses.

This embodiment of the method allows imaging on different planes of the substrate and thus producing multiple level devices.

A second application of the method is in the field of printing. An embodiment of the method, which is suitable to form part of a process for printing a sheet of paper, is characterized in that the radiation sensitive layer is a layer of electrostatic charged material.

The invention also relates to a method of manufacturing a device in at least one layer of a substrate, the method comprising the steps of:

forming an image in a radiation-sensitive layer provided on the substrate layer, which image comprises features corresponding to device features to be configured in the substrate layer and
removing material from, or adding material to, areas of the substrate layer, which areas are delineated by the image formed in the radiation-sensitive layer. This method is characterized in, that the image is formed by means of the method as described above.

Devices, which can be manufactured by means of this method and apparatus, are liquid crystalline display devices, polymer LED (Polyled) display devices, customer-specific ICs, electronic modules, printed circuit boards MEMS (integrated micro-electrical-mechanical systems) and MOEMS (integrated micro-optical-electrical-mechanical systems) etc. An example of such a system is and integrated optical telecommunication devices comprising a diode laser and/or detector, a light guide, an optical switch and possibly a lens between the light guide and the diode laser, or the detector. The method and apparatus can also be used for patterning mask for several applications.

These and other aspects of the invention are apparent from and will be elucidated, by way of non-limitative example, with reference to the embodiments described hereinafter.

### IN THE DRAWINGS

FIG. 1 shows schematically shows an embodiment of a lithographic apparatus wherein the invention can be used;

FIG. 2a shows a top view of a portion of a refractive lens array used in this embodiment;

FIG. 2b shows a top view of a portion of a light valve array used in this embodiment;

FIG. 2c shows a top view of a portion of the array of spots formed in the resist layer by means of this embodiment;

FIGS. 3a-3c show, in a cross-section view, different moments of the printing process;

FIG. 4 shows the principle of skew scanning of an array of spots and a resist layer relative to each other;

FIG. 5a show a bottom view of a micro lens array plate adapted according to the invention and of the sensing module;

FIG. 5b shows a cross section of this plate and module and the exposure spots formed by means of the lens array;

FIG. 6 shows a top view of slit pairs in the upper surface of the sensing module;

FIG. 7 shows the way in which a slit pair scans a spot;

FIG. 8 shows the radiation pulses generated during such a scan;

FIG. 9 shows how the position of a spot in the scan direction can be determined;

FIG. 10 shows how the position of a spot in a direction perpendicular to the scan direction can be determined;

FIG. 11 shows how the size of a spot can be determined;

FIG. 12 shows how the intensity of a spot can be determined;

FIG. 13 shows an embodiment of a lithographic apparatus comprising a projection lens system wherein the invention can be used, and

FIG. 14 shows an embodiment of a printing apparatus wherein the invention can be used.

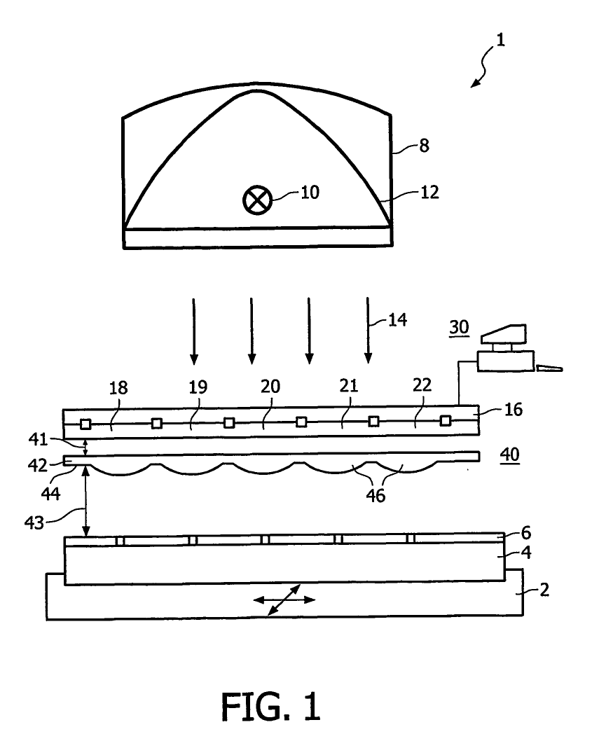

FIG. 1 shows, very schematically, a conventional proximity printing apparatus 1 for the manufacture of, for example a LCD device. This apparatus comprises a substrate holder 2 for carrying a substrate 4 in which the device is to be manufactured. The substrate is coated with a radiation-sensitive, for example a photo resist, layer 6 in which a pattern, having features corresponding to the device features, is to be imaged. The apparatus further comprises an illumination unit 8. This unit may comprise a lamp 10, for example, a mercury arc lamp, and a reflector 12. This reflector reflects lamp radiation, which is emitted in backward and sideways directions towards the resist layer 6. The reflector may be a parabolic reflector and the lamp may be positioned in a focal point of the reflector, so that the radiation beam 14 from the radiation source is substantially a collimated beam. Other or additional optical elements, like one or more lenses, may be arranged in the illumination unit to ensure that the beam 14 is substantially collimated.

The pattern to be imaged is generated by means of a light valve device 16 comprising an array of light valves. The device 16 is for example a two-dimensional liquid crystal display (LCD) or digital mirror device (DMD), which devices are well known for displaying information. The LCD display may be a transmission or a reflective display. The pattern may also be generated by means of a linear array of light valves, such as a grating light valve (GLV) array in combination with a scanning element, which scans the sub-beams from the light valve array in a direction perpendicular to the length direction of the linear array. Device 16 comprises a large number of light valves, also called pixels (picture elements). Only a few of them, 18-22 is shown in FIG. 1. The light valve device 16 is controlled by a computer configuration 30 (not on scale) wherein the pattern, which is to be configured in a substrate layer is introduced in software. The computer thus determines at any moment of the writing process and for every light valve whether it is closed, i.e. blocks the portion of the illuminating beam 14 incident on this light valve, or is open, i.e. transmits this portion to the resist layer 6. FIG. 1 the beam 14 illuminates only a few light valves 18-21. However, in reality this beams illuminates all light valves of the device 16 simultaneously and the beam 14 is a rather broad beam.

Between the array of light valves and the resist layer 6 an imaging, or converging, plate 40 is arranged. This plate comprises a transparent substrate 42 and an array 44 of radiation converging elements 44. The number of these elements corresponds to the number of light valves and the array 44 is aligned with the array of light valves so that each converging element belongs to a different one of the light valves. The converging elements 46 may be diffractive elements, such as Fresnel zone lenses. Preferably, the elements 46 are refractive lenses. Such lenses allow focusing of radiation from corresponding light valves in spots, which are smaller than those obtained with diffraction lenses. Moreover the optical performance of these lenses is substantially less dependent on the wavelength of the radiation than that of a diffraction element.

As the radiation source, the substrate holder and the mask holder are less relevant for understanding the new method; these elements will not be described in detail.

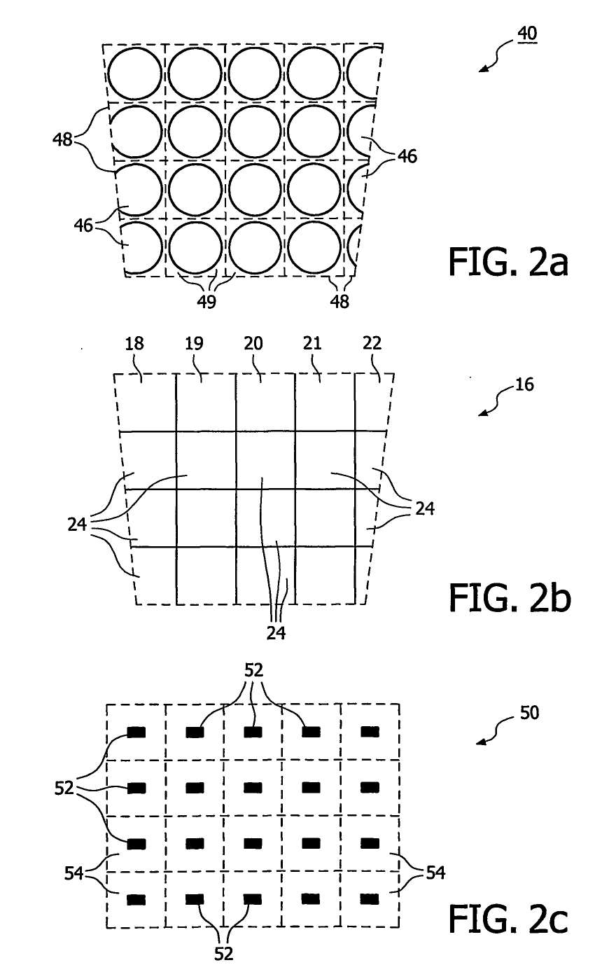

FIGS. 2a and 2b show a top view of a portion of the array 44 of refractive micro lenses 46 and the corresponding portion of the array 16 of light valves 18-22 and further light valves 24. The array 44 includes a number of cells 48 each comprising a central transmission portion 46, shaped as a micro lens, and a surrounding border portion 49. The border portion of a cell flows in the border portion of the neighbouring cells and the border portions together constitute a black matrix. Such a black matrix reduces cross talk between the beam portions passing through the individual lenses. The border portions of all cells may be constituted by a radiation absorbing or reflecting layer. The size of the spots formed in the resist layer and the depth of focus of the beam portions forming these spots is determined by the power of the lenses 46. By means of a spot shaping aperture (not shown) arranged in the illumination unit the shape of the produced spots can be adapted to a required application. These spots may be, for example, round, rectangular, square or diamond shaped. The geometric structure of the lens array 42 of the converging plate 40 is adapted to the geometric structure of the light valve array. The converging plate 40 is arranged at a distance 41 from the light valve device 16 such that as much as possible of the radiation from a light valve passes through an associated lens 46 and is concentrated in the spot produced by this lens and that a minimum amount of background radiation occurs.

FIG. 2c shows a small portion of the array 50 of spots 52 obtained by means of the lens array of FIG. 2a, if the corresponding portion of the light valve array is illuminated with radiation having a wavelength of, for example 365 nm and all light valves of the portion are open. The exposure spots 52 have a size of, for example, of the order of 2 μm². The distance 43 between the lens array 42 and the resist layer 6 is, for example, 250 μm.

Usually, the micro lenses 46 are spherical lenses; i.e. their curved surface is a portion of a perfect sphere. If necessary, aspherical lenses may be used. An aspherical lens is understood to mean a lens, which basic surface is spherical, but which actual surface deviates from spherical in order to correct for spherical aberrations a spherical lens may produce.

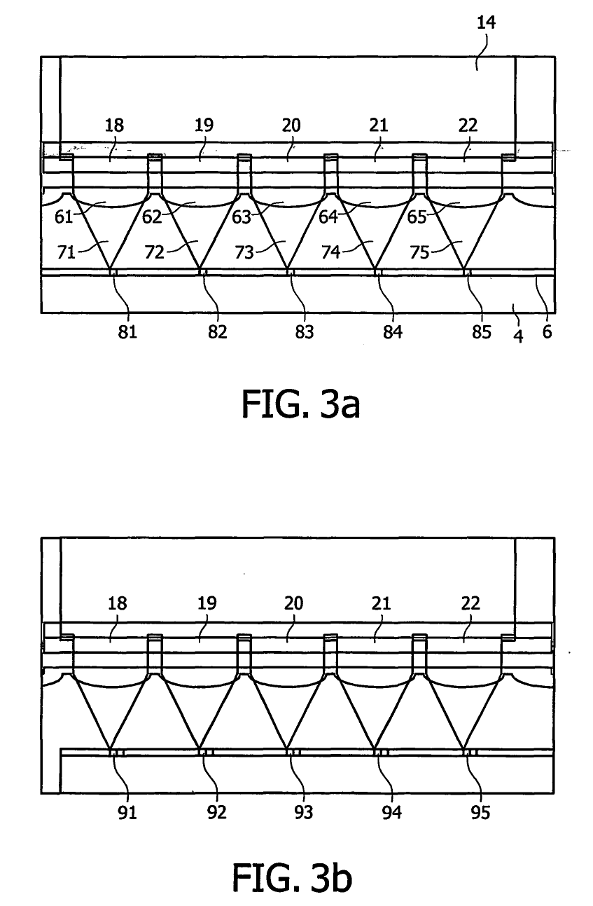

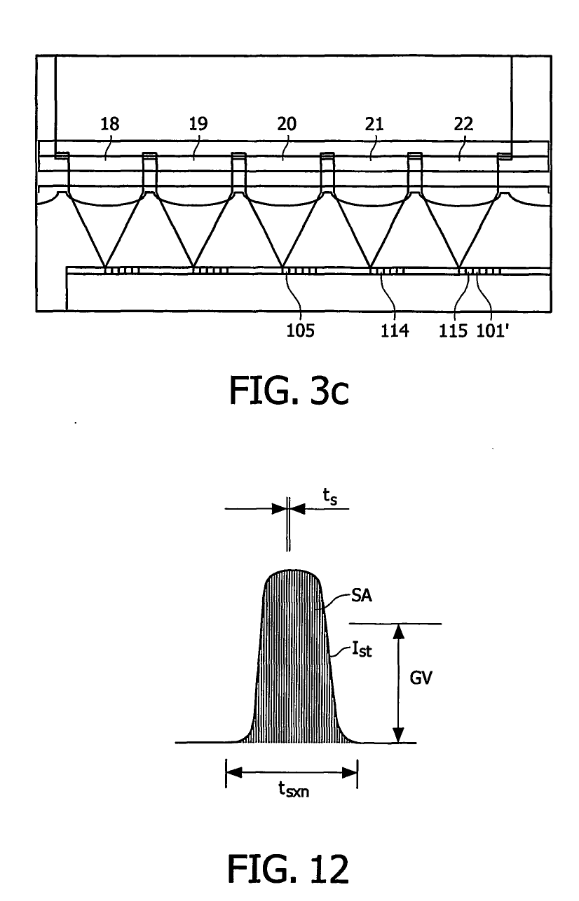

The spots 52 shown in FIG. 3c are rectangular spots. These spots may also be round or squared or may have any other shape, which is deemed appropriate.

In case diffractive elements are used for the converging elements 46, the parameters of these elements, such as the periodicity, or pitch of an element structure, the phase difference introduced by this structure and the duty cycle of the structure, can be adapted to obtain the required exposure spot size and shape. The duty cycle of a periodic structure is understood to mean the ratio of the width of an (annular) strip of the structure and the local pitch, i.e. the sum of the width of a strip and the neighbour intermediate strip.

As discussed in the PCT application IB 03/01372 (PHNL020310), the array of micro lenses may produced by a lithographic technique or by a replication-from-a-mould technology.

As shown in FIG. 2c, each spot 52 occupies only a small, point-like portion of the resist layer area 54 belonging to the light valve which determines whether this spot is present at a certain moment or not. Hereinafter the point-like resist areas will be called spot areas and the resist area 54 belonging to a light valve will be called light valve area. To obtain full features, i.e. lines and areas, of the image pattern corresponding to the device features to be produced, the substrate with the resist layer at the one hand and the two arrays at the other hand should be displaced relative to each other. In other words, each spot should be moved in its corresponding valve area 54 such that this area is fully scanned and illuminated at prescribed, i.e. feature-determined, positions. Most practically this is realized by displacing the substrate stepwise in a grid like pattern. The displacement steps are of the order of the size of the spots, for example of the order of 1 μm or smaller. A portion of the valve area belonging to a given spot, which portion is destined for an image feature or part thereof, is exposed in flashes. For displacing the substrate holder in steps of 1 μm or smaller with the required accuracy, use can be made of servo controlled substrate stages used in lithographic projection apparatus and which operate with an accuracy of well below 1 μM, for example of the order of 10 nm.

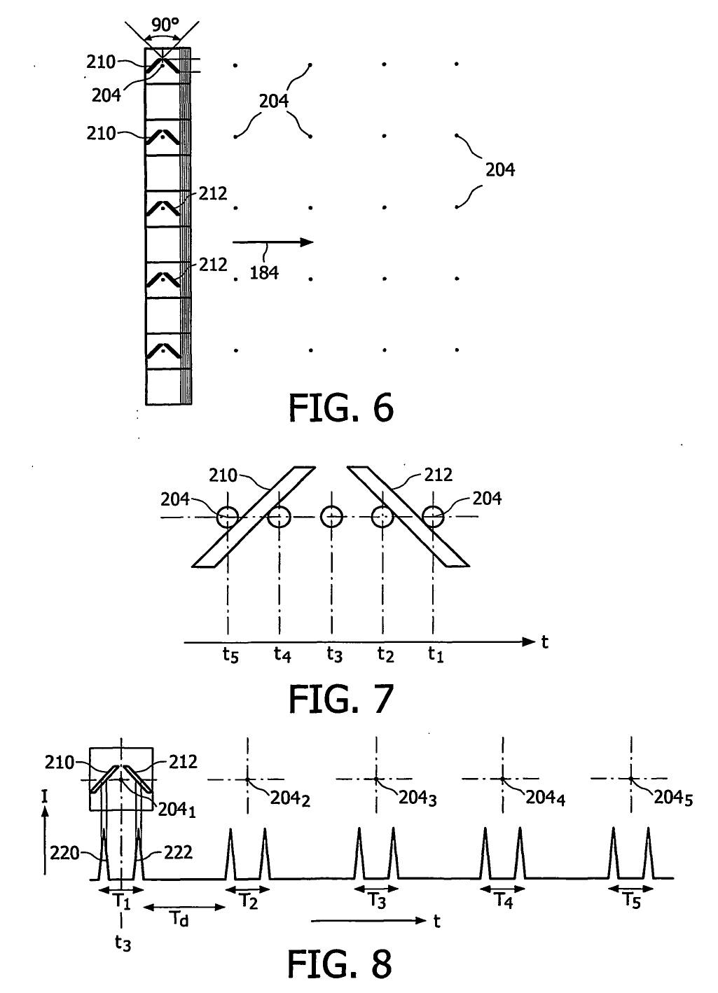

The exposure process of flashing and stepping is illustrated in FIGS. 3a-3c, which show a small portion of the array of light valves, the array of refractive lenses and the resist layer. In these Figs., the reference number 14 denotes the illuminating beam incident on the light valves 18-22. Reference numbers 71-75 denote the sub-beams passed by open light valves and converged by the corresponding refractive lenses 61-65. FIG. 6a presents the situation after a first sub-exposure has been made with all light valves open. At that moment a first set of spot areas 81-85, one spot area in each light valve area, has been exposed. FIG. 3b presents the situation after the substrate has made one step to the right and a second sub-exposure has been made also with all light valves open so that a second set of spot areas 91-95 has been exposed. FIG. 3c presents the situation after the substrate has made five steps and six sub-exposures have been made. During the fourth sub-exposure light valves 20 and 21 were closed so that spot areas 103 and 105 were have not exposed. During the fifth sub-exposure the light valves 21 and 22 were closed so that spot areas 114 and 115 were not exposed. As shown in the Figure all other spot areas have been exposed.

By the successive steps of displacing the resist layer and opening or closing light valves individually any required pattern can be written. Scanning of a valve area with a spot can be performed serpentine wise, i.e. a first line of the area is scanned from left to right, a second line from right to left, a third line from left to right again, etc.

Instead of the stepping mode, illustrated in FIGS. 3a-3c, also a scanning mode can be used to produce the required image patterns. In the scanning mode the resist layer at the one hand and the arrays of light valves and refractive lenses at the other hand are continuously moved with respect to each other and the light valves are flashed when they face a prescribed position on the resist layer. The flash time, i.e. the open-time of the light valve, should be smaller than the time during which the relevant light valve faces the said position.

Instead of a lamp, also other radiation sources may be used, preferably lasers, especially lasers used currently or to be used in the near future in wafer steppers and wafer-step-and scanners, emitting radiation with a wavelength of 248, 193 and 157 nm, respectively. Lasers provide the advantage that they emit a beam, which has a single wavelength and is collimated to the required degree. Essential for the present imaging method is that the illumination beam is substantially a collimated beam. With a fully collimated beam, i.e. a beam having an aperture angle of 0°, the best results are obtained. However also with a beam having an aperture angle smaller than 1° satisfactorily results can be obtained.

The required movement, with respect to each other, of the resist layer at the one hand and the array of light valves and the array of micro lenses at the other hand is most practically performed by movement of the substrate stage. Substrate stages currently used in wafer steppers are very suitable for this purpose, because they are more than accurate enough. It will be clear that movement of the substrate stage, for either the stepping mode or the scanning mode, should be synchronized with switching of the light valves. To that end, the computer 30 of FIG. 2, which controls the light valve array, may also control the movement of the stage.

An image pattern larger than the illumination field of one array of light valves and one array of refractive lenses can be produced by dividing, in the software, such a pattern into sub-patterns and successively transferring the sub-patterns to neighbouring resist areas having the size of the image field. By using an accurate substrate stage the sub-image patterns can be put together precisely so that one non-interrupted large image is obtained.

A large image pattern can also be produced by using a composed light valve array and a composed refractive lens array. The composed light valve array comprises, for example, five LCD's, each having 1000×1000 light valves. The LCD's are arranged in series to cover, for example, the width of the image pattern to be produced. The composed refractive lens array is constructed in a corresponding way to fit to the composed light valve array. The image pattern is produced by first scanning and exposing a resist area having a length covered by a single array of light valves and a width covered by the series of light valve arrays. Subsequently the substrate with the resist layer and the series of arrays are displaced relative to each other in the length direction over a distance covered by a single array. Then a second resist area, which now faces the composed arrays is scanned and exposed, etc until the whole image pattern has been produced.

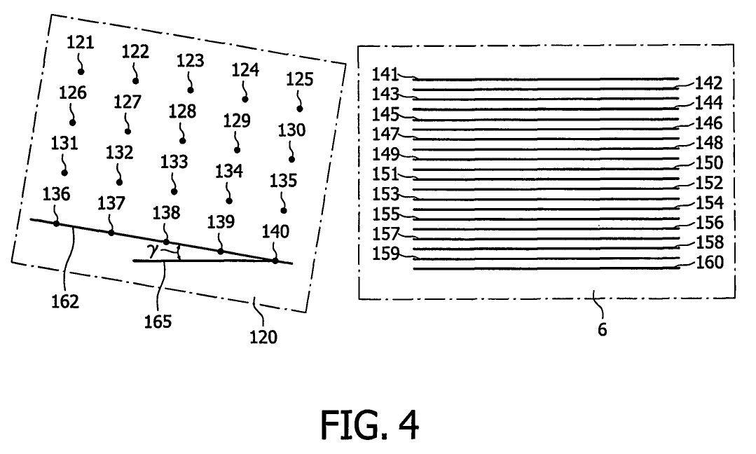

Instead of scanning its own light valve area, each of the spots may also scanningly write a resist area, which in one direction has a dimension considerably larger than that of said light valve area, whilst a number of spots are used to write said resist area in the other direction. This principle shown in FIG. 4 The left-hand part of FIG. 4 shows a small portion 120 of the exposure spot matrix, which portion comprises four rows of each five spots 121-125, 126-130, 131-135 and 136-140, respectively. The right-hand part of FIG. 4 shows the portion of the resist layer 5, which can be written, by the spots 121-140. The direction 162 of the lines of spots is now at a small angle γ with respect to the direction 165 along which the spots and the resist layer are moved relative to each other. This angle is chosen such that the spots of one line of spots when projected upon the Y-axis fit within the Y inter space between this line of spots and the next line of spots and fill up this inter space. When the substrate is scanned in the X direction, each spot scans its own line across the resist layer. The lines 141-145 in the right hand part of FIG. 4 are the centre lines of the small, for example 1 μm wide, strips scanned by the spots 121-125. The spots 126-130 scan the lines 266-270, respectively, and so on.

For a matrix of 100×100 spots each having a dimension of 1×1 μm², which matrix covers an image field of 10×10 mm², the spot period is 100 μm in the X and Y direction. In order to achieve that the hundred spots of one row scan hundred successive lines in the resist layer, the angle γ between the scan direction and the direction of lines of the spots should be: γ=arctan (1/100)=0.57°. By scanning each spot in the X-direction over 10 mm the whole field of 10×10 mm² can be written, without moving the spots and the resist layer relative to each other in the Y direction. Due to run-in and run-out of the spots the total scanning distance is larger, for example 20 mm, than the effective scanning distance of 10 mm. The scanning distance needed for run-in and run-out is dependent on said angle γ. For a larger matrix of spots, for example 1000×1000 spots, the ratio of effective scanning distance and total scanning distance is considerably increased.

By decreasing the distance between the spots, the centres of the strips written by the spots can be decreased and the density of the written pattern can be increased. This allows to impart redundancy to the system and to avoid that a spot failure results in a hard error.

Skew scanning may also be used in a system for imaging a large pattern and comprising a composed light valve array and a corresponding composed refractive lens array. For example, with a system comprising five LCD arrays arranged in series in the Y-direction and each producing, within an image field of 100×100 mm², 1000×1000 spots with lines of spots at the above-mentioned angle of 0.57° a resist area of 500×100 mm² can be written by scanning the resist layer 10 mm in the X-direction. After the resist layer has been moved 90 mm in the X direction, the same scan can be repeated. In this way a resist area of 500×1000 mm² can be written by scanning and moving ten times in the x direction only.

The number of scans and intermediate movements needed for writing a given area depends on the number of light valves, and thus the number of spots, in the X and Y direction. For example with an array of 5000×100 spots a resist area of 500 mm in the y direction can be written by continuously scanning in the X direction without intermediate movement. The scan length determines the length in the X direction of the written area.

The apparatus allows manufacturing a device composed of sub-devices, which are positioned at different levels. Such a device may be a pure electronic device or a device that comprises two or more different types of features out of the diversity of electrical, mechanical or optical systems. An example of such a device is a micro-optical-electrical-mechanical system, known as MOEMS. A more specific example is a device comprising a diode laser or a detector and a light guide and possibly lens means to couple light from the laser into the light guide or from the light guide to the detector. The lens means may be planar diffraction means. For the manufacture of a multilevel device, a substrate is used that has a resist layer deposited on different levels. Preferably a multiple level device is produced by dividing software-wise the total image pattern in a number of sub-images each belonging to a different level of the device to be produced. In a first sub imaging process a first sub-image is produced whereby the resist layer is positioned at a first level. The first sub imaging process is performed according to the, scanning or stepping, method and by the means described herein before. Then the resist layer is positioned at a second level and in a second sub imaging process the sub-image belonging to the second level is produced. The shining of the resist layer in the Z-direction and the sub-imaging processes are repeated until all sub-images of the multiple level device are transferred to the resist layer.

For accurate and reliable imaging a required pattern in a resist layer, the quality of the exposure spots and the positions of these spots with respect to alignment marks in the substrate layer to be configured according to this pattern should be monitored. According to the invention the monitoring comprises switching all light valves in the “on” state so that all spots should be present and scanning the array of spots with a moving sensing module. This module is provided with X- and Y encoders, which co-operate with gratings on the lens plate so that the positions of the spot with respect to this gratings and with respect to alignment marks, which are arranged close to the grating, can be determined accurately.

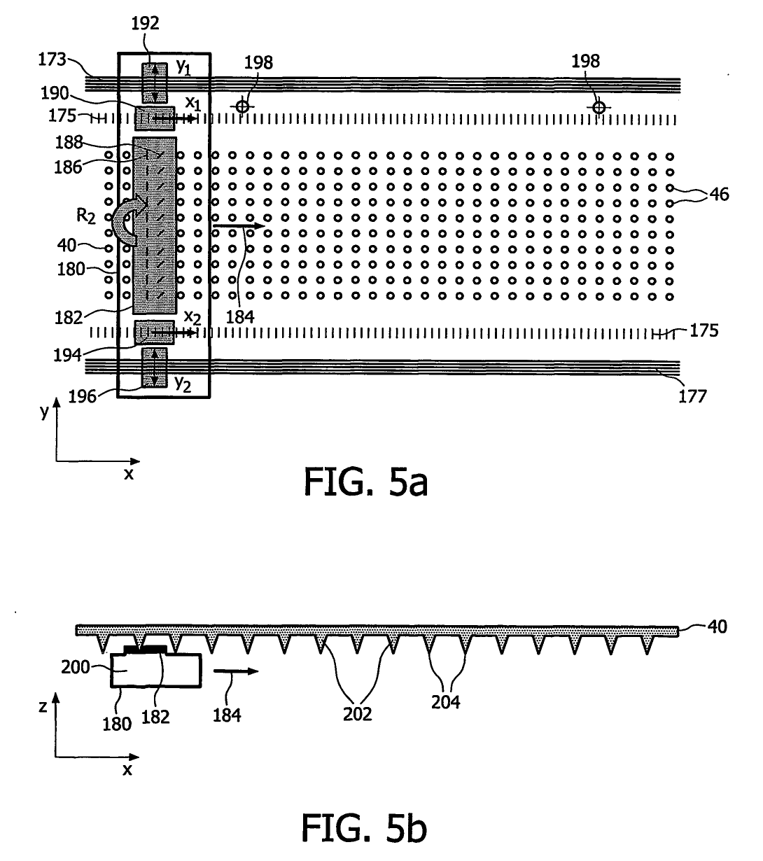

FIG. 5a shows a bottom view of the sensing module and a portion of the lens plate 40 with the regular pattern of micro lenses 46 and FIG. 5b shows a vertical cross-section of the plate and the module. According to the invention the lens plate is provided with a tracking configuration in the form of a grating 171, which is arranged outside the micro lens area and is composed of short grating strips extending in the Y-direction. This grating will be used for determining X-position. The lens plate may also be provided with an Y-tracking configuration in the form of a grating 173, which is composed of long grating lines extending in the X-direction. This grating is used for determining deviations in the Y direction of the module movement. The gratings 171 and 173 may be amplitude gratings, i.e. gratings having transparent grating strips, which alternate with non-transparent intermediate strips. Preferably, the grating are phase gratings, i.e. gratings having their transparent grating strips at a different level than the, also transparent, intermediate strips. The phase gratings may be etched in the lens plate.

The sensing module is denoted by reference number 180. During the inspection and alignment mode, this module will be moved in the X-direction as denoted by the arrow 184. The upper side of the module comprises a non-transparent plate, which is provided with one series, but preferably two series of transparent slits 186 and 188, respectively. The upper side may be formed by a transparent plate of glass, or another transparent material, which is coated by a layer of, for example chromium. The slits may be etched in this coating. FIG. 5a may suggest that the module is arranged above the lens plate, in reality however the module is beneath the lens plate as clearly shown in FIG. 5b. The slits having the same Y-position of the two series form a pair. Below these slit pairs a linear array of radiation-sensitive detectors 200, for example photo diodes is arranged in the module. These detectors may be formed by the detector cells of a CCD sensor or a CMOS sensor. The number of the detectors corresponds to the number of slit pairs and the arrangement is such that each detector receives radiation from another the slit pair. The number of slit pairs may be equal to the number of micro lenses in the Y-direction. Then all micro lenses shown in FIG. 5b can be monitored during one movement of the sensing module in the X-direction. It is also possible that the number of slit pairs is smaller than the number of micro lenses in the Y direction. In that case more than one movement of the sensing module is needed to monitor all micro lenses.

FIG. 5b shows the convergent sub-beams 202 from one line of micro lenses, which form spots 204. In the embodiment of this Figure only one spot of the X-line is scanned at any moment, whilst a number of spots, for example equal to the number of detector pairs, of an Y-column are scanned simultaneously. As will be explained later on, in addition to the position of the spots, also the size of the spots and the exposure dose, i.e. the intensity, per spot can be determined by means of the sensing module 180.

If the exposure spots were directly observed by a camera CCD or CMOS sensor, the sub-beams forming these spots would had been focused on the sensor cells and an effective sensor pixel would had been very small, for example of the order of 0.1 μm. By observing a spot via one or two slit(s), i.e. the spot forming sub-beam is focused on the slit(s), the spot illuminates a substantially larger portion of the sensor and the sensor pixel is much larger, for example of the order of 100 μm. The measuring resolution of the system with the slits is determined by the number samples per time unit that are taken in by the electronic processor, which processes the signals from the sensor. The use of the slits allows considerably reducing the amount of measuring data to be processed.

The slits 186 of the first series may extend in the Y-direction and then allow determining the X-position of the individual spots with respect to the sensing module 180. The slits 188 of the second series may be arranged at an angle of, for example 45° with respect to the X- and Y-direction and then allow determining of the Y-position of the individual spots with respect to module

In order to measure the positions of the exposure spots with respect to the tracking configurations, e.g. gratings 171 and 173 on the lens plates, the sensing module is provided with an X-encoder 190 and an Y-encoder 192. Such an encoder comprises a grating having a structure corresponding to the structure of the lens plate grating with which it co-operates and a radiation-sensitive detector arranged below the encoder grating. If the encoder grating moves across the corresponding lens plate grating, the detector supplies a pulsed signal and by counting the pulses the position of sensing module with respect to the lens plate can be determined. It will be clear that the encoder 190 will supply information about the X-position of the module 180, whilst the encoder 192 will provide information about deviations in the Y-direction of the sensor movement. Such deviations can also be determined by a capacitive or inductive sensor, which measures the distances from the sensor to the side of the module facing the sensor. If such a sensor is used, the module does not comprise an Y-encoder and the lens plate does not comprise a tracking configuration 192.

A shown in FIG. 5a, the module may be provided with a second X-encoder 194 and the lens plate may be provided with a second grating 175 having its grating strips extending in the Y-direction. This allows measuring the X-position of a second portion of the module with respect to the lens plate. By subtracting the signals from the encoders 192 and 194 from each other, it can be determined whether the sensing module is rotated with respect to the lens plate around a Z-axis, i.e. an axis normal to the lens plate. Measuring such a rotation, which is denoted by the curved arrow R_{z} in FIG. 5a, allows correcting the measured X- and Y-positions for this rotation. The module may also be provided with a second Y-encoder 196 and the lens plate may be provided with a second grating having its grating strips extending in X-direction. By subtracting the signals from the encoders 192 and 196 from each other a possible extension of the lens plate, resulting in shifting of the individual lens positions, may be determined. This allows correcting the measured X- and Y-positions for such extension. The extension may be caused by heating of the lens plate by, for example the exposure radiation, an actuator or the environment.

In this way the positions of the spots with respect to the positions references, i.e. the gratings, on the lens plate can be determined. The lens plate is further provided with alignment marks 198, two of which are shown in FIG. 5a. Since these marks are arranged close to gratings 171 and 173 the position of the spots with respect to these marks can be determined very accurately. In lithography the substrate to be processed is provided with alignment marks, which during the alignment procedure are aligned with respect to corresponding alignment marks in the photo mask. The means for and the procedure of alignment are well known for conventional lithography. Now the substrate alignment marks are aligned with respect to the alignment marks 198 in the lens plate. In this way the positions of the exposure spots with respect to substrate can be determined very accurately. The alignment marks in the lens plate and the substrate may be of any type, such as boxes, gratings, chevrons etc.

Instead of a first series of slits 186 extending in the Y-direction and a second series of slits 188 extending at 45° with respect to the slits 186, preferably two series of slits extending at +45° and −45°, respectively are used. FIG. 6 shows some of the slits 210 and 212, respectively of such series and a portion of the matrix of exposure spots 204, which have to be scanned by the sensing module. Each spot 204 is scanned by two slits 210 and 212 arranged at an angle of 45° with respect to the direction of movement of the sensing module and mutually at an angle of 90°.

FIG. 7 shows the positions of one spot with respect to the slits 212 and 210 at different moments in time in case the slits are moving to the right with respect to the spot 204. t₁ is the moment at which radiation from the spot starts to enter slit 212 and reaches the detector cell, or pixel, associated with slits 210 and 212, thus the moment at which detection of the spot by means of slit 212 begins. This detection ends at moment t₂, when no longer radiation from the spot enters the slit 212. During the time interval from t₂ to t₄ no radiation is incident on the detector. At moment t₄ spot detection by means of slit 210 starts, which detection ends at moment t₅. At moment t₃ the spot is midway the slits. Each time a pair of slits 210,212 moves across a spot the associated detector cell receives two radiation pulses and supplies two electrical pulses to the processing circuit connected to the detector array.

This is shown in FIG. 8, wherein the pulses of a pair associated with one spot are denoted by 220 and 222, respectively. Along the horizontal axis the time t is plotted and along the vertical axis the radiation intensity I received by the associated sensor cell is plotted along the vertical axis. The time interval during which the detector cell receives the two pulses is denoted by T. FIG. 8 shows five time intervals T₁-T₅ in which the detector cell receives radiation from five spots 204₁-204₅, which succeed each other in the X-direction. Dark time intervals, i.e. intervals during which the detector cell receives no radiation are denoted by T_{d}. The interval between the pulses of one pair is substantially shorter than the time interval T_{d}, so that pulses generated by one spot cannot be contributed to pulses of a preceding or a succeeding spot.

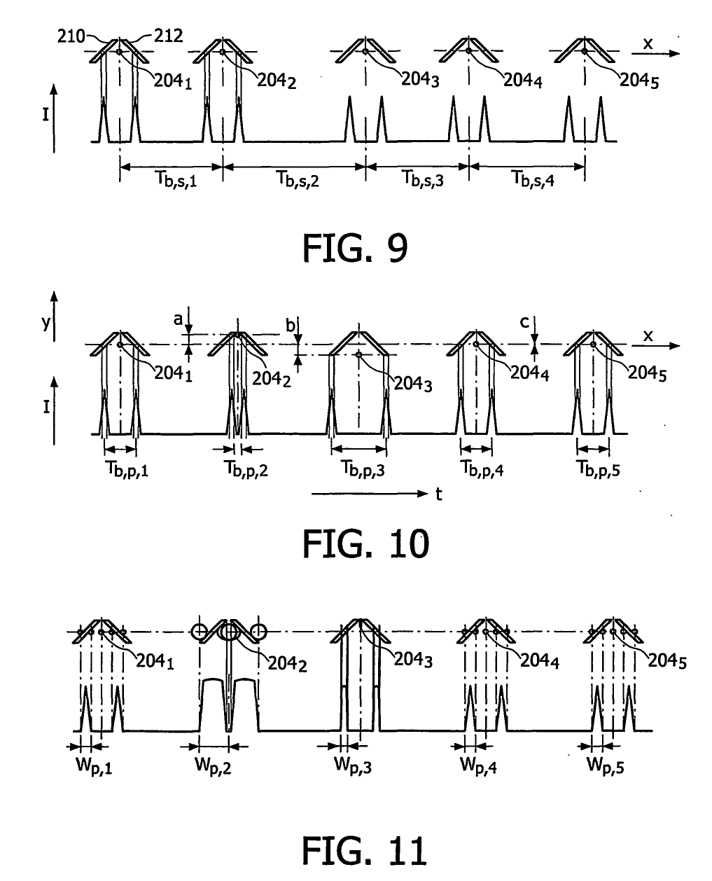

The X-position of a scanned spot can be derived from the time moment t₃, i.e. the moment at which the spot is midway the two slits of one pair. FIG. 8 represents the situation that the time intervals T_{d} are equal to each other, which implies that if one of the spot has the required X-positions, this will be also the case for the other spots. This is not the case for the situation shown in FIG. 9. This FIG. shows time intervals T_{b,s}, i.e. time intervals between the time moments t₃ associated with successive spots 204₁-204₅. The time interval T_{b,s,2} is larger and the time intervals T_{bs,1} and T_{b.s,3} are both smaller than time interval T_{b,s,4}. If time interval T_{b,s,4} is the required time interval, which means that the distance between spots 204₄ and 204₅ is correct, the spot 204₂ is too close to spot 204₁ and spot 204₃ is too close to spot 204₄.

FIG. 10 shows how the Y-position of the exposure spots can be determined. The slit plate 182 of the sensing module 80 is positioned with respect to array of micro lenses such that if a spot has the required Y-position, this spot will, during its scanning, pass through the middle of the slits 210 and 212. The time interval T_{b,p} between the peaks of the two detector pulses generated by this spot then has a nominal value T_{bp,n}. The time intervals T_{bp,1}, T_{b,p,4} and T_{b,p,5} of the spots 204₁, 204₄ and 204₅, respectively are equal to the nominal time interval so that these spots have the required Y-position. The spot 204₂ is shifted a distance a in the +Y direction with respect to the nominal Y-position of the spots 204₁,204₄ and 204₅. This shift results in a decrease of the time interval between the peaks of the pulses generated by this spot; T_{b,p,3} is substantially smaller than T_{b,p,1}. The spot 402₃ is shifted a distance b in the −Y direction with respect to the nominal Y-position. This results in a time interval T_{b,p,3}, which is larger than the time interval T_{b,p,1}. By measuring the time interval T_{b,p} associated with a spot and comparing this interval with the nominal time interval, it can be determined if this spot has the required Y-position.

FIG. 11 shows how the size of a spot can be determined. The pulses generated by a spot having the required, nominal, size will have a nominal pulse width w_{p,n}. If the spot is larger, the time interval during which radiation from the spot passes the slits will be longer. If the spot is smaller, this time interval will be shorter. If in FIG. 11 the spots 204₁, 204₄ and 204₅ have the nominal size, the width w_{p,1}, w_{p,4} and w_{p,5}, respectively of the pulses generated by these spots will be equal to the nominal width w_{p,n}. The width w_{p,2} of the pulses generated by the spot 204₂ is substantially larger than the nominal width, which means that the spot 204₂ has a size larger than the nominal size. The width w_{p,3} of the pulses generated by the spot 204₃ is smaller than the nominal pulse width, which means that the spot 204₃ is smaller than the nominal size. The spot size can thus be determined by measuring the width of the pulses generated by the spot and comparing this width with the nominal width.

An important parameter in lithography is the so-called exposure dose, i.e. the radiation energy per unit surface area incident on the resist. In order to allow developing the resist after exposure, the exposure dose should be larger than a threshold value called minimum clearance dose. The total exposure dose supplied by an exposure spot is the product of the intensity of the spot and the time interval T_{sd} during which the spot is present. During measurement of an exposure spot, samples are taken in successive sample times tₛ. The samples times can be adapted to, for example the type and fines of measurement to be carried out. The smaller the sample time, i.e. the higher the number of samples taken during unit of time, the finer the measurement can be. The minimum sample tₛ is given by:

tₛ=1/f_{frame}

wherein f_{frame} is the frame rate of the CCD sensor, i.e. the frequency at which the sensor cells are read out. The sample times may be equal to each other or not. The frame rate may be constant. However, it is also possible to trigger read out of the sensor externally, for example by the signal supplied by a position encoder. The f_{frame} is the no longer constant and the sensor is read out at moments the position encoder is at pre-determined positions. In this way the spot measurement can be made insensitive to the speed of movement of the module.

Usually the spot has a Gaussian type intensity distribution so that in the successive sample times different energy levels are measured, which energy levels may be called grey values GV. The intensity Iₛₜ measured during a sample time is given by:

Iₛₜ=GV/tₛ

and the mean intensity Iₛₚ of the spot is given by:

Iₛₚ=ΣGV/n

Whereby the summation is over n, i.e. the number of sample taken during the presence of the spot above the relevant sensor cell or during one of the pulses generated by this spot shown in FIG. 12.

FIG. 12 shows the parameters, which are relevant for the measurement of the spot intensity. In this FIG. 5a denotes a sample. FIG. 12 does not need further explanation.

Since with the slit configuration shown in FIG. 6-12 the diameter of an exposure spot is measured two times, in two mutually perpendicular directions, this configuration allows detecting of deviations in the shape of the spot.

The above-described measurements can also be carried out with the pairs of slits shown in FIG. 5a, thus with one slit of each pair extending in the Y-direction and the other slit extending at 45° thereto.

When used in a lithographic apparatus described herein above, which apparatus is also called mask-less lithographic apparatus, the invention not only allows determining accurately both a number of spot parameters and the position of the spots, but also provides the advantages that production spots, i.e. the spots used for writing in a resist layer are monitored and that production radiation is used so that no wavelength correction is needed.

The invention can also be used in another type of mask-less lithographic apparatus. This apparatus comprises a projection system, for example a projection lens system or, in case deep UV (DUV) radiation or extreme UV (EUV) exposure radiation is used, a mirror projection system. The projection system images the array of light valves on the array of lenses, whereby each light valve is conjugated with a corresponding lens. The use of a projection system allows more freedom of design than allowed in the sandwich design of the FIG. 1 apparatus.

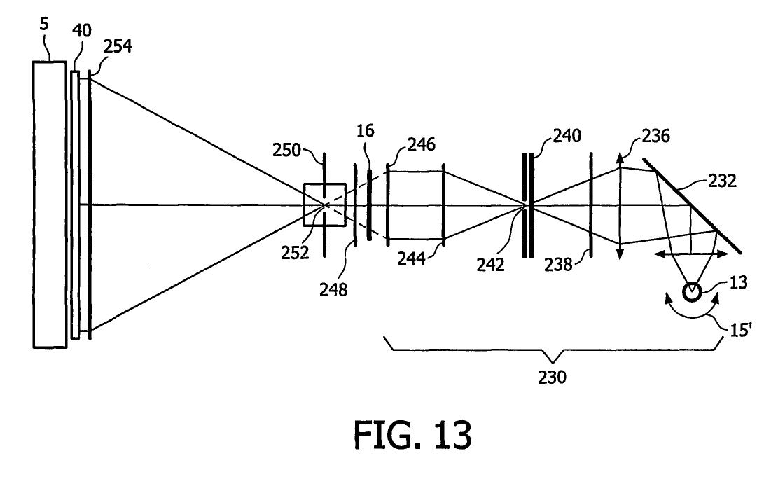

FIG. 13 shows such an apparatus with a projection lens, which may comprise a number of lens elements. The right part of FIG. 13 shows an illumination system 230, which may also be used in the apparatus of FIG. 1. This illumination system comprises a radiation source, for example a mercury lamp 10 and a reflector 12, which may have the shape of a half sphere. The reflector may be arranged with respect to the lamp such that no central obstruction of the illumination beam occurs. A laser may replace lamp 10 and reflector 12. The beam from the radiation source 10,12 is incident on a wavelength selective reflector, or dichroic mirror, 232, which reflects only the beam component with the required wavelength, for example UV or DUV radiation, and removes radiation of other wavelengths, such as IR or visible radiation. In the case the radiation source is a laser, no selective reflector is needed and either a neutral reflector can be arranged at the position of the reflector 232 or the laser can be arranged in line with the rest of the optical path. A first condensor lens system, for example comprising a first condensor lens 234 and a second condenser lens 236 arranged before and after the reflector 232, respectively, converges the illumination beam 14 on a radiation shutter 240. This shutter is provided with a diaphragm 242. The shape of this diaphragm determines the shape of the spots formed in the resist layer 6 and this diaphragm thus constitutes the spot-shaping aperture mentioned herein before. A second condensor system, for example comprising condensor lenses 244,246 concentrates the radiation passed by diaphragm 242 in the pupil 252, or diaphragm, of a projection lens system 250, i.e. it images diaphragm 242 in the plane of the pupil of the projection lens 250. The beam passing condensor lens 246 illuminates LCD 16, which is arranged between this condensor lens and the projection lens system 250. This system images the LCD on the micro lens array, or in general the converging plate, 40 such that each light valve (pixel) of the LCD is conjugated with a corresponding converging element (micro lens) of the converging plate (micro lens array) 40. If a light valve is open, the radiation from this valve is incident on the conjugated micro lens only. The micro lens array may be arranged at a distance of, for example 600 mm from the LCD. The distance between the micro lens array and the resist layer 6 may be of the order of 100 to 300 μm.

The pixels of the LCD 16 may have a size of 20 μM and the projection lens system 250 may image the LCD pixel structure on the micro lens array with magnification 5×. For such imaging no large numerical aperture (NA) for the projection lens system is required. To improve the collimatation of the illumination beam incident on the micro lens array, a collimator lens 254 may be arranged in front of this array. The projection lens system 250 and a micro lens together image the diaphragm opening into a spot. For example a diaphragm opening of 1 mm is imaged in a spot with a dimension of 1 μm. As the working of the LCD is based on changing the polarization state of incident radiation, a polarizer, which gives the radiation the required initial polarization state is needed. Also needed is a polarization analyzer, which converts a change in polarisation into an intensity change. This polarizer and analyser are denoted by reference numerals 246 and 248, respectively. The polarizer and the analyzer are adapted to the wavelength of the illumination beam. Although not shown in FIG. 1, a polarizer and analyzer are also present in the apparatus according to this FIG.

Since in an apparatus with a projection lens system the radiation from a LCD pixel is focused on the associated micro lens, practically no cross talk will occur in such an apparatus. By means of the projection lens the periodicity of the light valve array can be adapted to that of the micro lens array. Moreover using a projection lens allows provided the possibility to use a thick substrate for the converging plate so that the micro lens array is more stable. The polarizer and analyser used in an apparatus with a LCD light valve array absorb radiation and produce heat. If the polarizer and analyzer are arranged close to the LCD, which is usually the case, this may cause thermal effects. An apparatus wherein a projection lens is arranged between the LCD and the imaging element allows arranging the polarizer 228 remote from the LCD. In this way it is prevented to a high degree that thermal effects will occur. As shown in FIG. 13 also the analyzer 248 may be arranged at some distance from the LCD 16. Moreover the design of FIG. 13 allows separate cooling of the LCD. A LCD light valve array may comprise spacers in the form of small, for example 4 μm, spheres of a polymer material. Such spheres may cause optical disturbances. In an apparatus with a projection lens system the effects of the spacers are reduced because the projection lens system, which has a relative small NA functions as a spatial filter for the high frequency disturbances.

When using a projection lens system it becomes easily to replace a transmission light valve array by a reflective array, such as a reflective LCD or a digital mirror device (DMD). An apparatus wherein a DMD is used should be provided with spatial filtering means. These means should ensure that only radiation having a predetermined direction, i.e. radiation which is reflected by mirrors having a predetermined orientation, reaches the micro lens array 40 and the resist layer. A projection lens system provides such filtering function.

The apparatus of FIG. 13 is only one example of an apparatus with a projection lens. Many modifications of the FIG. 13 apparatus are possible.

Since the method of the invention for detecting presence or absence, due dust, a light valve failure etc., of exposure spots, determining their the position and monitoring their parameters is very fast, the method can be carried out before each exposure of a substrate. Dependent on the circumstances the method can also be carried less frequently, for example at the beginning of processing a batch of substrates or at the beginning of a working day. The method thus forms a first step in a lithographic printing process for manufacturing a device having device features in at least one process layer of a substrate. Application of the method makes the printing process insensitive for temperature drift. Moreover the method allows total control of the entire optical printing system.

After the required image has been printed in the resist layer on top of the process layer, material is removed from, or added to, areas of the process layer which areas are delineated by the printed image. These process steps of imaging and material removing or adding are repeated for all process layers until the whole device is finished. In those cases where sub-devices are to be formed at different levels and use can be made of multiple level substrates, sub-image patterns associated with the sub-devices can be imaged with different distances between the imaging element and the resist layer.

The invention can be used for printing patterns of, and thus for the manufacture of, display devices like LCD, Plasma Display Panels and Polyled Displays, printed circuit boards (PCB) and micro multiple function systems (MOEMS).

The invention can also be used in a mask-less lithographic apparatus wherein the converging element comprises diffractive elements instead of micro lenses. The invention can not only be used in a lithographic proximity printing apparatus but also in other kinds of image forming apparatus, such as a printing apparatus or a copier apparatus.

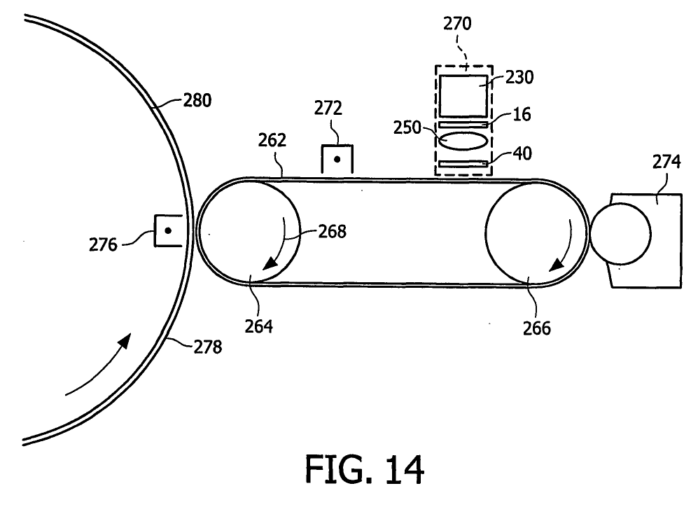

FIG. 14 shows an embodiment of a printer 260, which comprises an array of light valves and a corresponding array of converging elements. The printer comprises a layer 262 of radiation sensitive material, which serves as an image carrier. The layer 262 is transported by means of two drums, 264 and 266, which are rotated in the direction of arrow 268. Before arriving at the exposure unit 270 the radiation sensitive material is uniformly charged by a charger 272. The exposure station 270 forms an electrostatic latent image in the material 262. The latent image is converted into a toner image in a developer 274 wherein supplied toner particles attach selectively to the material 262. In a transfer unit 276 the toner image in the material 262 is transferred to a transfer sheet 278, which is transported by a drum 280. At the beginning of the printing process the exposure spots furnished by the exposure station can be monitored and their positions determined by means of the method and the sensing module as described herein above for the lithographic apparatus.

In general, most effectively the sensing module is moved in a direction perpendicular to the scan direction, i.e. the direction in which the resist layer is moved with respect to the arrays of converging elements and of light valves during exposure of the resist layer. This allows simultaneously monitoring of the spots and handling of the substrate, i.e. feeding the substrate with resist layer in the apparatus. The information, obtained during such monitoring, about the spot positions can be compared with data in a look-up table and the results of such a comparison can be used to adapt the writing process and apparatus. The intensity measurement supplies information about which spot(s) should not be used and which spot(s) should replace the non-usable spot(s).

1. An apparatus for forming an optical image in a radiation-sensitive layer, which apparatus comprises:
a radiation source for supplying an exposure beam of radiation;
positioning means for positioning a radiation sensitive layer with respect to the radiation beam;
an array of individually controllable light valves arranged between the radiation source and the location for the radiation-sensitive layer, and
a two-dimensional array of converging elements arranged on a converging plate between the array of light valves and the substrate holder such that each converging element corresponds to a different one of the light valves and serves to converge exposure beam radiation from the corresponding light valve in a spot area in the radiation-sensitive layer, characterized by monitoring means for individually monitoring the spots formed by the convergent elements and/or for determining the positions of these spots with respect to the radiation sensitive layer, which means are arranged downstream the array of convergent elements and use the exposure beam radiation.

2. An apparatus as claimed in claim 1, characterized in that the monitoring means comprises a movable module, which is provided with a slit plate comprising an array of slits and with a corresponding array of radiation detectors in register with the slits.

3. An apparatus as claimed in claim 2, characterized in that the slit plate comprises a first and a second series of slits whereby the slits of the first and second series extend in different directions with respect to the direction of movement of the sensing module.

4. An apparatus as claimed in claim 3, characterized in that the slits of the first series and the slits of the second series extend in a direction at a first sharp angle and in a direction at a second sharp angle, opposed to the first sharp angle, respectively the said direction of movement.

5. An apparatus as claimed in claim 2, characterized in that the sensing module comprises at least one X-position encoder and at least one Y-position encoder, and in that the converging plate is provided with at least one X-tracking configuration and at least one Y-tracking configuration.

6. An apparatus as claimed in claim 5, characterized in that the sensing module comprises two X-position encoders and two Y-position encoders, and in that the converging plate is provided with two X-tracking configurations and two Y-tracking configurations.

7. An apparatus as claimed in claim 4, characterized in that the converging plate comprises a number of alignment marks to co-operate with corresponding alignment marks on the substrate

8. An apparatus as claimed in claim 7, characterized in that the alignment marks are arranged close to the tracking configurations.

9. An apparatus as claimed in claim 1, characterized in that the converging elements are diffraction elements.

10. An apparatus as claimed in claim 1, characterized in that the converging elements are refractive lenses.

11. An apparatus as claimed in claim 1, characterized in that the array of converging elements faces the array of light valves without intervening imaging elements.

12. An apparatus as claimed in claim 1, characterized in that an optical projection system is arranged between the array of light valves and that array of converging elements.

13. An apparatus as claimed in claim 1, forming a lithographic tool for producing a device in at least one layer of a substrate, characterized in that the radiation-sensitive layer is a resist layer on top of a substrate layer to be configured, in that the image corresponds to the pattern of device features to be configured in said substrate layer and in that the positioning means is a substrate holder carried by a substrate stage.

14. An apparatus as claimed in claim 1, for printing data on a sheet of paper, characterized in that the radiation-sensitive layer is a layer of electrostatic charged radiation-sensitive material and in that the positioning means are means for moving said layer with respect to the array of light valves and the array of converging elements and for sustaining said layer at the location of the image field of this array.

15. A method of forming an optical image in a radiation sensitive layer, the method comprising the steps of:
providing a radiation source for generating a beam of radiation;
providing a radiation sensitive layer;
positioning an array of individually controlled light valves between the radiation source and the radiation sensitive layer;
positioning a two-dimensional array of radiation converging elements between the array of light valves and the radiation sensitive layer such that each of these elements corresponds to a different one of the light valves and serves to converge radiation from the corresponding light valve in a spot in the radiation sensitive layer;
simultaneously writing image portions in radiation sensitive layer areas by scanning said layer areas at the one hand and the associated light valves/converging element pairs at the other hand relative to each other and switching each of the light valves between on and off states in dependency of the image portion to be written in by the light valve, characterized in that, prior to writing an image in the radiation-sensitive layer, all light valves are switched on and a control process is carried out to determine parameters of the individual spots and/or the positions of these spots with respect to the radiation-sensitive layer.

16. A method as claimed in claim 15, characterized in that the control process comprises the step of scanning the array of spots and a measuring module comprising an array of slits and a corresponding array of radiation detectors with respect to each other.

17. A method as claimed in claim 16, characterized in that the control process comprises the step of determining the position of the measuring module with respect to the lens array by measuring the positions of linear encoders included in the module with respect to tracking configurations in the converging plate.

18. A method as claimed in claim 17, characterized in that the control process comprises the step of determining the positions of the spots with respect to the radiation-sensitive layer by measuring the positions of alignment marks, which are included in the converging plate, with respect to corresponding alignment marks in the substrate.

19. A method as claimed in claim 15, characterized in that said scanning is such that each spot scans its own associated layer area, which area has dimensions corresponding to the pitch of the matrix of spots formed by array of converging elements.

20. A method as claimed in claim 15, characterized in that the matrix of spots and the radiation sensitive layer are scanned relative to each other in a direction at a small angle to the direction of the lines of spots in the matrix and in that the scanning is carried out over a length substantially larger than the matrix pitch.

21. A method as claimed in claim 15, characterized in that the between successive sub-illuminations the radiation-sensitive layer and the arrays are displaced relative to each other over a distance, which is at most equal to the size of the spots formed in the radiation sensitive layer.

22. A method as claimed in claim 15, characterized in that the intensity of a spot at the border of an image feature is adapted to the distance between this feature border and a neighbouring feature.

23. A method as claimed in claim 15, forming part of a lithographic process for producing a device in at least one layer of a substrate, characterized in that the radiation sensitive layer is a resist layer provided on the substrate layer to be configured and in that the image corresponds to the pattern of device features to be configures in the substrate layer.

24. A method as claimed in claim 23, characterized in that the image is divided in sub-images each belonging to a different level of the device to be produced and in that during formation of the different sub-images the resist layer surface is set at different distances from the array of refractive lenses.

25. A method as claimed in claim 15, forming part of a process for printing a sheet of paper, characterized in that the radiation sensitive layer is a layer of electrostatic charged material.

26. A method of manufacturing a device in at least one layer of a substrate, the method comprising the steps of:
forming an image in a radiation-sensitive layer provided on the substrate layer, which image comprises features corresponding to device features to be configured in the substrate layer and
removing material from, or adding material to, areas of the substrate layer, which areas are delineated by the image formed in the resist layer, characterized in that the image is formed by means of the method as claimed in claim 15.
